(19) United States
(12) Patent Application Publication
(10) Pub. No.: US 2024/0283803 A1
(43) Pub. Date: Aug. 22, 2024

(54) SYSTEM AND METHOD FOR DETECTING AND MITIGATING DATA SECURITY ATTACKS

(71) Applicant: EDGEHAWK SECURITY LTD., Tel Aviv (IL)

(72) Inventors: LIOR FITE, ZURIT (IL); ASAF ORON, EVEN YEHUDA (IL)

(21) Appl. No.: 18/110,377

(22) Filed: Feb. 16, 2023

(51) Int. Cl. H04L 9/40; G06F 17/18

(52) U.S. Cl. CPC H04L 63/1425; G06F 17/18

(57) ABSTRACT

Analyzing telemetry data used in a quantile system having multiple quantile units, by receiving performance properties that define operational boundaries of the quantile system, receiving the telemetry data over a communication network, executing a target function that outputs changes to operational parameters of the quantile system to meet the operational boundaries using the received telemetry, and updating the operational parameters of the quantile system according to an output of the target function.

### FIELD

The invention relates generally to the field of Cyber Security, and more particularly to methods to detect and mitigate data security attacks over a data network.

### BACKGROUND

Monitoring and analysis of data over a communication network are essential for security and management tasks. In high-speed links, it is not always possible to process all the incoming packets, and sampling techniques (for example, Sampled NetFlow) must be applied to reduce the load on routers. That is, only some of the packets are monitored.

A Quantile system can be very effective in finding anomalies in data sent over networks. Standard quantile systems comprise multiple quantile units used to identify features in the data sent over the network. For example, a simple quantile system may distribute the received telemetry records into quantile units that have the same single feature equally among all quantile units (i.e., bandwidth in all quantile units is equal or substantially equal). As more Telemetry information is received via the network, one of the quantile units' bandwidths might increase un-proportionally compared to the other quantile units, demonstrating an anomaly in bandwidth growth to a specific part of the network.

### SUMMARY

In one aspect of the invention a method is provided for analyzing telemetry data used in a quantile system having multiple quantile units, the method comprising receiving performance properties that define operational boundaries of the quantile system, receiving the telemetry data over a communication network, executing a target function that outputs changes to operational parameters of the quantile system to meet the operational boundaries using the received telemetry, updating the operational parameters of the quantile system according to an output of the target function.

In some cases, the method further comprises assigning specific pieces of the received telemetry data to specific quantile units.

In some cases, the target function receives as input the received telemetry data and performance properties.

In some cases, the performance properties comprise at least one of analysis time, analysis accuracy and a false-positive rate.

In some cases, the method further comprises updating a number of quantile units in the quantile system based on the target function and performance of the quantile system.

In some cases, the method further comprises computing a time interval required by the quantile units to sample the telemetry data and determine an interval anomaly.

In some cases, the method further comprises computing a number of interval anomalies required by the quantile units to determine a data security threat in the telemetry data.

In some cases, the operational parameters of the quantile system include a number of quantile units and a telemetry collection time window.

In some cases, assigning specific pieces of the received telemetry data to specific quantile units is performed according to a specific property in the telemetry data.

In some cases, the method further comprising calculating a minimum value of telemetry samples per time interval per quantile unit.

In some cases, the method further comprising calculating an optimal number of telemetry samples per time interval per quantile unit.

In some cases, the method further comprising calculating a false positive rate per time interval per quantile unit. In some cases, the method further determining a false positive rate for the quantile system.

In some cases, computing the interval anomaly comprising computing an average load of the quantile units in the quantile system, computing a load difference between the load of a specific quantile unit and the average load of the quantile units, comparing the load difference to a load threshold.

In some cases, the method further comprising computing a system probability density according to analysis done by the quantile units, comparing the system probability density to a normal probability density.

In another aspect of the invention a quantile system is provided having multiple quantile units and a processor configured to execute a set of instructions, the set of instructions comprising receiving performance properties that define operational boundaries of the quantile system, receiving the telemetry data over a communication network, executing a target function that outputs changes to operational parameters of the quantile system to meet the operational boundaries using the received telemetry, updating the operational parameters of the quantile system according to an output of the target function.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 shows a computerized environment for handling and processing data received over a communication network, according to exemplary embodiments of the present invention.

FIG. 2 schematically shows computerized components of a quantile system used for handling and analyzing data transferred over a network, according to exemplary embodiments of the present invention.

FIG. 3 shows a method for adjusting a quantile system, according to exemplary embodiments of the present invention.

FIG. 4 shows a method for computing the value of a working point of a quantile system, according to exemplary embodiments of the present invention.

The following detailed description of embodiments of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION

The present invention suggests a new system and method to dynamically calibrate a Quantile system. The quantile system is configured to detect network anomalies in an environment with high jitter and a low telemetry sampling rate. A quantile unit is defined as an independent component for receiving telemetry data from a network, for example via a router, and detecting anomalies in the telemetry. A quantile system comprises multiple quantile units and allocates data to the quantile units according to a set of rules, for example, sending all packets with a specific characteristic to a specific quantile unit. Each quantile unit may use separate computer resources, such as a separate memory, a separate processor, and the like.

The invention, in embodiments thereof, provides methods and systems for adjusting the operation of the quantile system. Adjusting may comprise adjusting the number of quantile units operating on a given time interval based on a set of rules and the telemetry received at the quantile system.

The system receives multiple performance properties to define the envelope of its performance. The system periodically changes the internal quantile distribution and collection window of the telemetry sample to meet the multiple performance properties. The multiple performance properties may include:
1. Detection time—the amount of time it takes the system to detect an anomaly from the received telemetry.
2. Detection accuracy—the minimum size of an anomaly in a specific feature as compared with the same feature in the rest of the quantile units to detect an anomaly. The size may be measured in bits. The size is a numerical value.
3. False positive rate-what is the maximum allowed false positive rate in a time interval

According to the above parameters and the real-time rate of telemetry samples, the system computes and updates properties of the quantile system. The properties may include:
Number of Quantile units
Telemetry sample collecting time interval
The number of consecutive positive detections to detect an anomaly

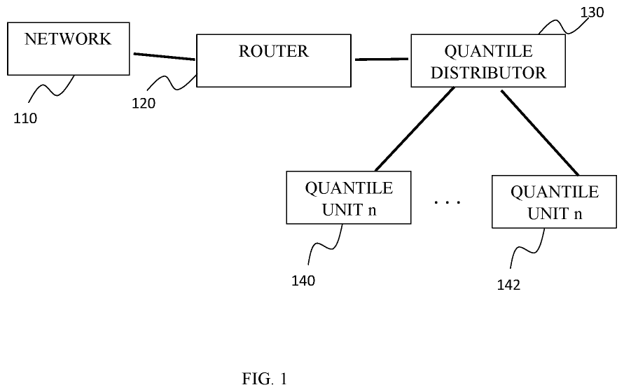

FIG. 1 shows a computerized environment for handling and processing data received over a communication network, according to exemplary embodiments of the present invention. The computerized environment shows a communication network 110 configured to transfer data, for example via antennas, cables, switches, routers, and the like. The data is associated with an identifier of a device that is the data's destination, for example the identifier may be an IP address. The data may be transferred via a router 120 towards the destination device. The router 120 sends at least some of the packets directed to the destination device to a quantile distributor 130 for analysis. This way, the data sent to the destination device is sampled by the quantile units 140, and 142 to detect anomalies that indicate a data security attack.

The router 120 receives packets from multiple source devices, for example from attacking devices used or controlled by attacking entities. The attacking devices send packets via the router 120 in order to attack other devices, for example by identifying open ports in various devices connected to the communication network. The communication network may be the internet, internet exchange (peering), may be a cellular network, a Local Access Network (LAN), and the like. The various devices may be virtual workloads residing in a public cloud or a private cloud or local data center, servers, personal computers, laptops, machines connected to the communication network such as manufacturing machines, sensors and the like.

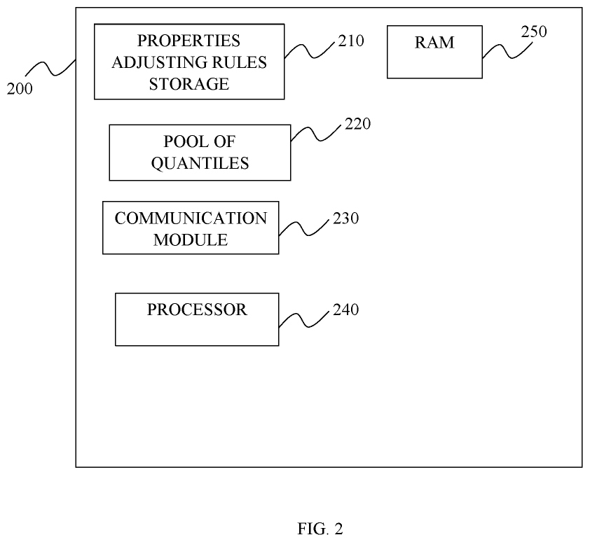

The quantile distributor 130 may be connected to or be an integral part of a quantile system having multiple quantile units configured to receive the telemetry data and detect anomalies in the telemetry. The anomaly detection may be performed based on a set of rules stored in a memory address accessible to the quantile units. The quantile system is configurable in the sense that at least one of the following properties of the quantile system can be configured: 1. Number of Quantile units. 2. Telemetry sample collecting time interval. 3. The number of consecutive positive detections required to detect an anomaly. Configuring the properties may be done by updating a value in a memory address configured to store a value indicating the property's value. Updating may be performed in response to computing a function that receives as input at least some of the telemetry data, or analysis of the telemetry data, and values representing the performance properties. The function may be updated according to changes in the analysis target of the quantile distributor 130. The quantile system is elaborated in FIG. 2.

FIG. 2 schematically shows computerized components of a quantile system used for handling and analyzing data transferred over a network, according to exemplary embodiments of the present invention.

The quantile system 200 comprises a set of quantile units 220. Each quantile unit operates independently, in the sense that data is sent to a specific quantile unit. The quantile units 220 may use different techniques or processes, or the same techniques. The quantile units 220 may be used to identify different features in the data or the same feature. The pool of quantiles 220 executes a set of instructions stored in a computerized memory. The quantile units may be coupled to the quantile distributor 130 that distributes the data among the quantile units. The number and type of quantile units in the pool of quantiles 220 may vary from one detection system to another.

Adjusting the number of quantile units 220 may be performed by enabling or disabling quantile units, or by assigning new quantile units to analyze the telemetry data. in order to adjust the number of quantile units operating in or for the quantile system in a given time stamp or time interval. For example, the central unit sends 3,000 bits per second to each quantile unit. Based on the nature of the telemetry data, and based on the operational properties of the quantile system, the central unit may send telemetry data to additional quantile units, or stop sending telemetry to quantile units that detected anomalies.

Disabling may be done by changing a value in a memory address of the memory used by the quantile system 200, for example, a RAM 250.

The quantile system 200 comprises a properties adjusting rules storage 210 for storing rules that dictate how to adjust the properties of the quantile system. The adjustable properties may be the detection time (the amount of time it takes the system to detect an anomaly from the received telemetry), detection accuracy (the minimum size of an anomaly in a specific feature as compared with the same feature in the rest of the quantile population to detect an anomaly) and a False positive rate (the maximum allowed false positive rate in a time interval).

The quantile system 200 comprises a communication module 230. The communication module is configured to receive data and transmit data. The communication module 230 may use any communication technique or protocol desired by a person skilled in the art, such as wireless signals, cellular communication, WAN, LAN, optical fibers, and the like.

The quantile system 200 comprises a processor 240 configured to execute a set of instructions stored in the quantile system, or in another device, in order to perform the processes disclosed herein. The processor 240 may be a hardware-based processor, a microprocessor, a general-purpose processor, and the like.

The quantile system 200 comprises a RAM 250 configured to store data, such as rules and instructions executed by the processor 240 when performing the processes disclosed herein. The RAM 250 may represent any kind of memory storage that can be updated by software commands.

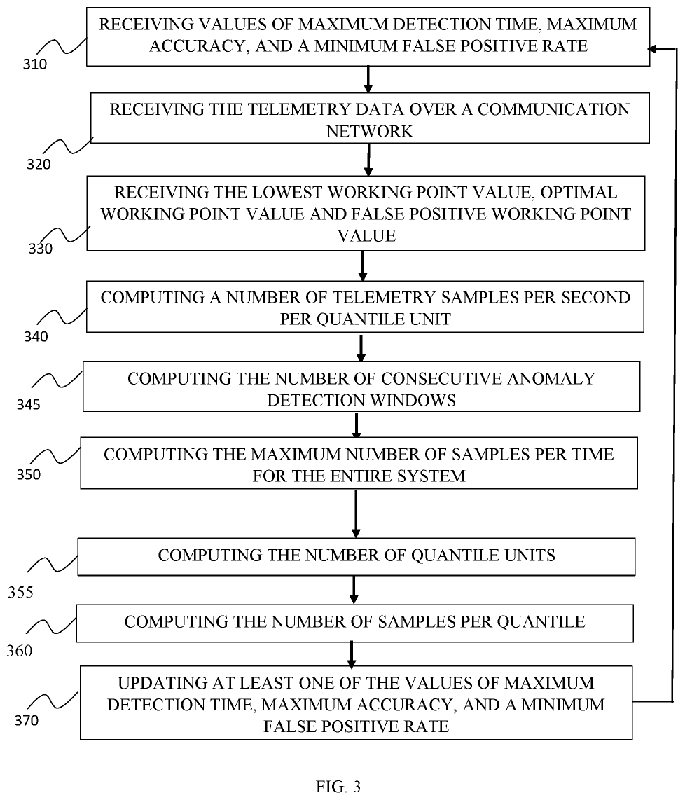

FIG. 3 shows a method for adjusting a quantile system, according to exemplary embodiments of the present invention.

The method is done in an iterative manner, such that at least one of the values of the maximum detection time, maximum accuracy, and a minimum false positive rate is adjusted after each iteration, depending on values computed by the system, for example, the number of samples per quantile in a given time interval.

Step 310 discloses receiving values of maximum detection time, maximum accuracy, and a minimum false positive rate. In the first iteration, the values are initial values. The initial values may be predefined, for example, a maximum detection time of 12 seconds, an accuracy of 75%, and a false positive rate of 0.1.

The accuracy of the detection is set by the number of quantile units in the system and the level above average in which an anomaly of a specific feature is detected. For example, an accuracy of 1% can be achieved in a system of 50. Quantile units when an anomaly is detected when an anomaly value outputted by one of the quantile units is 50% above the average values of the feature being monitored. Another option would be in a system of 100 quantile units and the anomaly is detected when a quantile value is 100% above the average values of the feature being monitored.

After the first interval, the values of the maximum detection time, maximum accuracy, and minimum false positive rate are adjusted based on computations done by the system and a set of values and provided back to the function.

Step 320 discloses receiving the telemetry data over a communication network. The telemetry may comprise metadata, such as the source IP, destination IP, Protocol, Port, TCP flags, and the like. The telemetry data may first be received at a central unit, for example a gateway, which in turn sends the telemetry data to a specific quantile unit for analysis. In some cases, a specific packet is analyzed by a single quantile unit in the quantile system.

Step 330 discloses computing the quantile system's working point based on a function that receives as input the telemetry and the values of maximum detection time, maximum accuracy, and a minimum false positive rate

Step 340 discloses computing a number of telemetry samples per second per quantile unit. The average telemetry samples per second per quantile unit may be computed by accumulating the amount of data analyzed by all the active quantile units in the quantile system and dividing the accumulated value by the number of active quantile units.

Step 345 discloses computing the number of consecutive anomaly detection windows. A detection window is defined as a time interval, for example, 1.5 seconds, in which a quantile unit operates to identify a feature or a time interval in which the packets used to identify the feature were received at a device, such as the quantile distributor. The number of consecutive windows for anomaly detection may be increased in case the minimal value of false positive of the quantile system is not satisfied. For example, in case the minimal false positive rate of the system is lower than a threshold, increase the number of windows by 1.

Step 350 discloses computing the maximal number of samples per time for the entire system. The maximal number of samples per time unit may be computed as the number of telemetry samples per time interval multiplied by the detection time and divided by the number of consecutive windows required to detect an anomaly.

Step 355 discloses computing the number of quantile units. The number of quantile units may be computed according to the accuracy required by the system, which is computed according to the accuracy of the feature detection, for example 1, or another constant, divided by the accuracy. Accuracy: the accuracy of the detection is set by the number of quantiles in the system and the level above average in which an anomaly is detected, for example, an accuracy of 1% can be achieved in a system of 50. Quantiles when an anomaly is detected when a quantile value is 50% above the average values of the feature being monitored. Another option would be in a system of 100. Quantiles when an anomaly is detected when a quantile value is 100% above the average values of the feature being monitored.

Step 360 discloses computing the number of samples per quantile unit. The number of samples per quantile may be computed as the number of samples per time interval divided by the number of quantile units.

Step 370 discloses updating at least one of the values of maximum detection time, maximum accuracy, and a minimum false positive rate. The updating may be performed in case the number of samples per quantile unit is lower than the system's working point. Updating the values of the maximum detection time, maximum accuracy, and a minimum false positive rate may be done based on a case that resulted from the parameter that requires optimization. In case the minimal false positive value requires optimization, the system will increase the value of the consecutive windows required to detect an anomaly and set the values of the maximum accuracy, and a detection time to a minimal value.

In case the minimal detection time value requires optimization, the system will decrease the value of the detection time and set the values of the maximum accuracy, and consecutive windows required to detect an anomaly to a minimal value.

In case the maximum accuracy value requires optimization, the system will decrease the value of the maximum accuracy and set the values of the detection time and a consecutive windows required to detect an anomaly to a minimal value.

Updating the values of the three operational parameters of the quantile system may be done according to the condition that initiated the updating. For example, in case the condition relates to the detection time, updating may include decreasing the detection time by a predefined value, assigning the detection window a minimal value and the analysis accuracy a minimal value.

In case the condition relates to the false positive value, updating may include increasing the detection window by a predefined value, assigning the detection time a minimal value and the analysis accuracy a minimal value.

In case the condition relates to the maximum accuracy, updating may include decreasing the analysis accuracy by a predefined value, assigning the detection window a minimal value and the detection time a minimal value.

After updating the values of at least one of the maximum detection time, maximum accuracy, and a minimum false positive rate, the method proceeds at step 310, inputting the new values into the function, until reaching a termination condition, either predefined or adjustable.

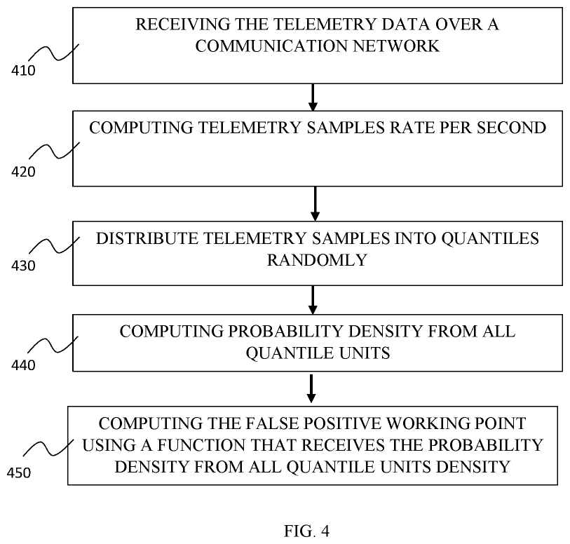

FIG. 4 shows a method for computing the working point of a quantile system, according to exemplary embodiments of the present invention.

Step 410 discloses receiving the telemetry data over a communication network. The telemetry may comprise metadata, such as the source IP, destination IP, Protocol, Port, TCP flags and the like. The telemetry data may first be received at a central unit, for example, a quantile distributor, which in turn sends the telemetry data to a specific quantile unit for analysis. In some cases, a specific packet is analyzed by a single quantile unit in the quantile system.

Step 420 discloses computing telemetry samples rate per second. The average telemetry samples per second may be computed by accumulating the amount of data analyzed by all the active quantile units in the quantile system and dividing the accumulated value by the number of active quantile units. The active quantile units are defined as quantile units used to process telemetry data in a given time interval or a time stamp.

Step 430 discloses distributing telemetry samples into quantiles randomly. The distribution may be performed by copying the telemetry samples into memory addresses assigned to specific quantiles units. The telemetry samples may be distributed in a random manner, or based on characteristics of the telemetry samples, such as source IP, destination IP, port number and the like.

Step 440 discloses computing probability density from all quantile units. The probability density defines a likelihood that a certain number of packets per second (PPS) or Bits per second (BPS) will be measures in a certain quantile unit. In standard port scanning attacks, traffic related to the attack needs to have 200% of normal traffic. The incentive is to compare the probability density with a threshold, such as 200% to estimate that there is no attack 2 times in a row, during 2 consecutive time intervals in which the quantile unit detects the samples telemetry.

Step 450 discloses computing the working point of the quantile system using a function that receives the probability density from all quantile units density. In some cases, the false positive rate is a value multiplied by the probability density, for example 200% of average quantile BPS or PPS. Even under no attack due to the statistical nature of traffic distribution between the quantile units, there is a chance that when measuring the traffic a specific quantile unit will be 200% from the average of the rest of the quantile units. This event is called “probability density”, and the probability of such event should be very low, for example 0.00001

A port scanning attack may be declared in case the probability density is higher than the threshold for a number of consecutive detection time intervals on a specific quantile. The false positive rate may be computed by calculating the probability density to the power of the consecutive detection time intervals. This way, adjusting the required false positive rate may be performed by increasing the required number of consecutive detection time intervals. In addition, or alternatively, one may increase the number of samples per quantile as it changes the probability density. For example, the more sample you have the probability density is lower.

It should be understood that the above description is merely exemplary and that there are various embodiments of the present invention that may be devised, mutatis mutandis, and that the features described in the above-described embodiments, and those not described herein, may be used separately or in any suitable combination; and the invention can be devised in accordance with embodiments not necessarily described above.

While the invention has been described with reference to exemplary embodiments, it will be understood by those skilled in the art that various changes may be made, and equivalents may be substituted for elements thereof without departing from the scope of the invention. In addition, many modifications may be made to adapt a particular situation or material to the teachings without departing from the essential scope thereof.

What is claimed is:

1. A method for analyzing telemetry data used in a quantile system having multiple quantile units, the method comprising:
receiving performance properties that define operational boundaries of the quantile system;
receiving the telemetry data over a communication network;
executing a target function that outputs changes to operational parameters of the quantile system to meet the operational boundaries using the received telemetry; and
updating the operational parameters of the quantile system according to an output of the target function.

2. The method of claim 1, further comprises assigning specific pieces of the received telemetry data to specific quantile units.

3. The method of claim 1, wherein the target function receives as input the received telemetry data and performance properties.

4. The method of claim 3, wherein the performance properties comprise at least one of analysis time, analysis accuracy and a false-positive rate.

5. The method of claim 1, further comprises updating a number of quantile units in the quantile system based on the target function and performance of the quantile system.

6. The method of claim 1, further comprises computing a time interval required by the quantile units to sample the telemetry data and determine an interval anomaly.

7. The method of claim 2, further comprises computing a number of interval anomalies required by the quantile units to determine a data security threat in the telemetry data.

8. The method of claim 1, wherein the operational parameters of the quantile system include a number of quantile units and a telemetry collection time window.

9. The method of claim 1, wherein assigning specific pieces of the received telemetry data to specific quantile units is performed according to a specific property in the telemetry data.

10. The method of claim 1, further comprising calculating a minimum value of telemetry samples per time interval per quantile unit.

11. The method of claim 1, further comprising calculating an optimal number of telemetry samples per time interval per quantile unit.

12. The method of claim 1, further comprising calculating a false positive rate per time interval per quantile unit.

13. The method of claim 8, further determining a false positive rate for the quantile system.

14. The method of claim 1, wherein computing the interval anomaly comprises:
computing an average load of the quantile units in the quantile system;
computing a load difference between the load of a specific quantile unit and the average load of the quantile units; and
comparing the load difference to a load threshold.

15. The method of claim 1, further comprising:
computing a system probability density according to analysis done by the quantile units; and
comparing the system probability density to a normal probability density.

16. A quantile system having multiple quantile units and a processor configured to execute a set of instructions, the set of instructions comprising:
receiving performance properties that define operational boundaries of the quantile system;
receiving the telemetry data over a communication network;
executing a target function that outputs changes to operational parameters of the quantile system to meet the operational boundaries using the received telemetry; and
updating the operational parameters of the quantile system according to an output of the target function.
